(19) United States
(12) Patent Application Publication
(10) Pub. No.: US 2019/0363415 A1
(43) Pub. Date: Nov. 28, 2019

(54) MICROSTRIP CIRCULATOR

(71) Applicant: ZTE CORPORATION, Shenzhen (CN)

(72) Inventors: Ying SHEN, Chapel Hill, NC (US); Zhou LI, Chang'an District, Xi'an (CN); Zhiping FENG, Chapel Hill (CN); Edwin John NEALIS, Caru, NC (US)

(21) Appl. No.: 16/461,755

(22) PCT Filed: Nov. 14, 2017
(86) PCT No.: PCT/US2017/061524

§ 371 Date: May 16, 2019

Related U.S. Application Data
(60) Provisional application No. 62/424,192, filed on Nov. 18, 2016.

(51) Int. Cl. H01P 1/387; H01P 5/18

(52) U.S. Cl. CPC H01P 1/387; H01P 5/184

(57) ABSTRACT

A circulator includes a substrate having a blind hole. The substrate has one or more dielectric layers and one or more conductive layers, including a top conductive layer on a top surface of the substrate. The circulator includes a plurality of conductive microstrips formed on the top conductive layer on the top surface of the substrate and a ferrite disk positioned within the blind hole. A top surface of the ferrite disk is flush with a top surface of the plurality of conductive microstrips. The circulator further includes a flat metal film coupling a top surface of the ferrite disk to the conductive microstrips disposed on the top surface of the substrate.

### TECHNICAL FIELD

The disclosed embodiments relate to circulators used in radio systems.

### BACKGROUND

Microwave radios play an increasingly important role in backhaul connectivity because of their high flexibility and low cost. In a radio system, a circulator is often used in the front end of a transmitter/receiver (TX/RX) to increase the isolation between transmitted and received signals. A circulator is a non-reciprocal three- or four-port microwave device, in which a microwave or radio frequency signal entering any port is transmitted, in the ideal case, only to the next port in a rotation direction. This is called “non-reciprocal behavior” because the transmission between a first port and a second port is not the same as the transmission between the second port and the first port. A port in this context is a point where an external waveguide or transmission line (such as a microstrip or a coaxial cable), connects to the circulator. For a three-port circulator, a signal applied to port S1 only comes out of port S2; a signal applied to port S2 only comes out of port S3; and a signal applied to port S3 only comes out of port S1. To reduce cost and size, microstrip circulators are popular for low cost radios, while waveguide circulators are expensive, bulky and hard to integrate with printed circuit boards (PCB), which are widely used in electronic products.

Ferrite circulators are radio frequency circulators that include magnetized ferrite materials. They fall into two main classes: 4-port waveguide circulators based on Faraday rotation of waves propagating in a magnetized material, and 3-port “Y-junction” circulators based on cancellation of waves propagating over two different paths near the magnetized ferrite material. Waveguide circulators may be of either type, while more compact devices based on strip lines are of the 3-port type. Two or more Y-junctions can be combined in a single component to give four or more ports, but these differ in behavior from a true 4-port circulator. A permanent magnet produces magnetic flux through the magnetic ferrite material in the circulator.

Unfortunately, ferrite material is not suitable to be used as a microwave substrate due to its high resistivity and large anisotropy. Hence, in most circulators, use of ferrite material is limited to a small portion of the circulator and not as the substrate.

### SUMMARY

To address the aforementioned problems, some implementations provide a circulator that includes a substrate having a blind hole. The substrate has one or more dielectric layers and one or more conductive layers, including a top conductive layer on a top surface of the substrate. The circulator includes a plurality of conductive microstrips formed on the top conductive layer on the top surface of the substrate and a ferrite disk positioned within the blind hole. A top surface of the ferrite disk is flush with a top surface of the plurality of conductive microstrips. The circulator further includes a flat metal film coupling a top surface of the ferrite disk to the conductive microstrips disposed on the top surface of the substrate.

In some embodiments, the substrate includes a first ground plane formed from a respective conductive layer of substrate. The respective conductive layer is disposed within an interior of the substrate. The substrate further includes a second ground plane formed from a bottom conductive layer of the substrate. The bottom conductive layer is disposed on a bottom surface of the substrate. The circulator further comprises a magnet coupled with the second ground plane disposed on the bottom surface of the substrate.

In some embodiments, the circulator includes a second magnet coupled with a surface of the flat metal film that is distal to the top surface of the ferrite disk.

In some embodiments, the circulator includes a metal pin that is coupled with a surface of the flat metal film that is distal to the top surface of the ferrite disk.

In some embodiments, the flat metal film comprises a metallization layer on the top surface of the ferrite disk.

In some embodiments, the flat metal film is a flat metal plate.

In some embodiments, each of the plurality of conductive microstrips is electrically coupled by the flat metal film to pass a signal between respective conductive microstrips of the plurality of microstrips according to a rotation direction of the circulator.

In some embodiments, the circulator is a three-port microstrip circulator.

In some embodiments, the blind hole goes through a top dielectric layer of the substrate without going into any other dielectric layers of the substrate.

### BRIEF DESCRIPTION OF THE DRAWINGS

For a better understanding, reference should be made to the following detailed description taken in conjunction with the accompanying drawings, in which:

FIGS. 1A-1B illustrate a microstrip circulator having a ferrite disk floating on top of a substrate, in accordance with some embodiments.

FIGS. 2A-2B illustrate a microstrip circulator having a ferrite disk embedded in a top layer of a substrate, in accordance with some embodiments.

FIG. 3A is an illustration of a portion of a partially-integrated microstrip circulator, in accordance with some embodiments.

FIG. 3B is an illustration of a portion of a fully-integrated microstrip circulator, in accordance with some embodiments.

FIG. 4A illustrates an exploded view of a portion of a microstrip circulator, in accordance with some embodiments.

FIG. 4B illustrates an assembled view of the portion of the microstrip circulator shown in FIG. 4A, in accordance with some embodiments.

FIG. 5 illustrates an exploded view of a microstrip circulator with package parts, in accordance with some embodiments.

FIG. 6A is an illustration of a partially-integrated microstrip circulator assembly having a magnet on top of a flat metal layer of the microstrip circulator, in accordance with some embodiments.

FIG. 6B is an illustration of a fully-integrated microstrip circulator assembly having a metal pin on top of a flat metal layer of the microstrip circulator, in accordance with some embodiments.

Like reference numerals refer to corresponding parts throughout the drawings.

### DESCRIPTION OF IMPLEMENTATIONS

Reference will now be made in detail to various implementations, examples of which are illustrated in the accompanying drawings. In the following detailed description, numerous specific details are set forth in order to provide a thorough understanding of the present disclosure and the described implementations herein. However, implementations described herein may be practiced without these specific details. In other instances, well-known methods, procedures, components, and mechanical apparatus have not been described in detail so as not to unnecessarily obscure aspects of the implementations.

As used herein, the term radio frequency (RF) includes microwave frequencies. In some embodiments, RF frequencies are frequencies in the range extending from around 3 kHz to 300 GHz. In some embodiments, RF frequencies include very low frequency (VLF) signals, low frequency (LF) signals, medium frequency (MF) signals, high frequency (HF) signals, very high frequency (VHF) signals, ultra-high frequency (UHF) signals, super high frequency (SHF) signals, and extremely high frequency (EHF) signals. Microwave frequencies are generally in a band between 3 GHz to 300 GHz, but definitions may vary.

As used herein, the term “metal plate” means a distinct metal piece, such as a piece of sheet metal or foil. A metal plate is distinct from and not chemically bonded to an underlying surface, except indirectly (e.g., in the case of solder). The term “metallization layer” means a layer of metal deposited directly on an underlying surface using a metallization technique (e.g., a technique for coating metal on the surface of objects). A metallization layer is chemically bonded to the underlying surface. The term “metal film” is used to encompass both metal plates and metallization layers (e.g., aluminum foil is a metal film, but so is a metal coating on a surface).

As used herein, the term “microstrip” refers to a patterned metal layer that serves as one of the conductors in a microstrip transmission line. A microstrip has a dielectric on one side, but unlike a stripline, is not sandwiched in dielectric.

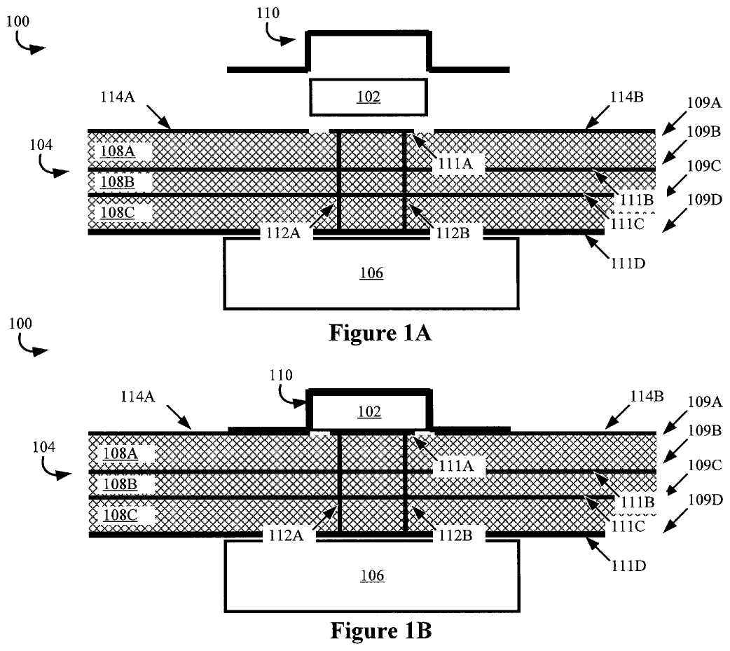

As noted above, integrating ferrite material with RF/Microwave circuit substrates is a challenge. To address this problem, FIGS. 1A-1B illustrate a conventional microstrip circulator 100 (FIG. 1A is a partially exploded view of FIG. 1B, which is an assembled view). A ferrite disk 102 is placed (e.g., floating) on top of a substrate 104. On the opposite side of substrate 104, circulator 100 includes a magnet 106 (e.g., a permanent magnet). As an example of substrate 104, FIGS. 1A-1B shows a three-layer printed circuit board (PCB). In some embodiments, a layer of a multi-layer PCB includes a layer of dielectric and a metal layer. For example, the three-layer PCB includes dielectric layers 108A-108C and conductive (e.g., metal) layers 109A-109D. One or more ground planes 111 (e.g., ground planes 111A-D) are formed from metal layers 109. In some embodiments, conductive circuit elements are patterned into the top metal layer 109A of substrate 104. For example, metal layer 109A is patterned into microstrips 114A-C and ground plane 111A (e.g., microstrips 114 and ground planes 111 are fabricated from the same metal layer 109A, but microstrips 114 are electrically isolated from each other on the substrate as well as from ground plane 111A). In some embodiments, ground plane 111C (the middle ground plane) is not necessary. In some embodiments, ground plane 111B is a ground plane for microstrip 114 and ground plane 111D is a common ground plane of the print board circuit. In some embodiments, ground planes 111 are connected (e.g., electrically coupled) by vias 112A-112B (e.g., conductive vias). Microstrip circulator 100 also includes a patterned metal plate 110 that is placed on top of ferrite disk 102. Patterned metal plate 110 carries a signal between microstrips 114 according to a rotation direction of circulator 100. An outer terminus of each microstrip 114 (e.g., a terminus distal to ferrite disk 102) comprises a port of circulator 100 (e.g., FIGS. 1A-1B illustrate two microstrips 114A and 114B in a three-port circulator).

Thus, in a geometry in which ferrite disk 102 is floating on substrate 104, patterned metal plate 110 has to be formed into a 3-D shape (e.g., by bending a patterned sheet of metal). This introduces many disadvantages, such as high cost, difficult assembly, and large impedance mismatching stemming from the tolerances needed to place a manufactured 3-D shape over ferrite disk 102.

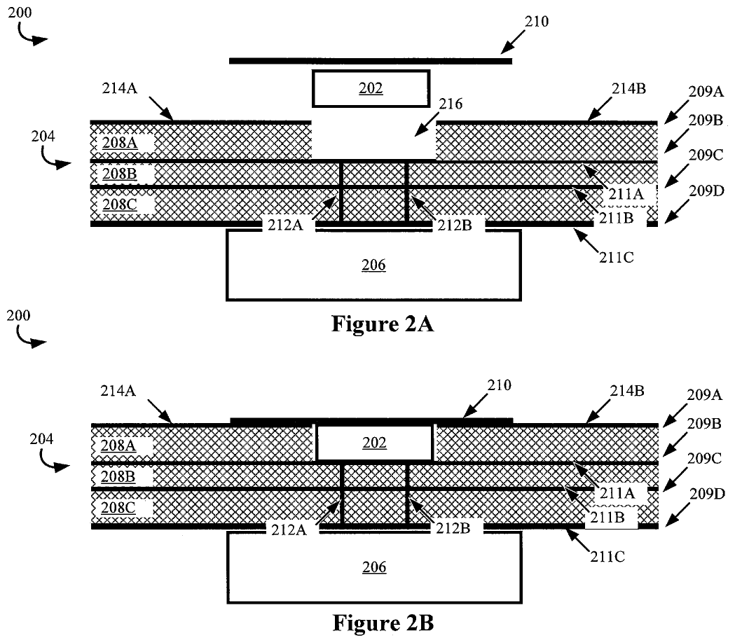

FIGS. 2A-2B illustrate an alternative geometry to that of FIGS. 1A-1B. In particular, FIGS. 2A-2B illustrate a microstrip circulator 200 having a ferrite disk 202 embedded in the top layer of a substrate, in accordance with some embodiments.

Circulator 200 includes a substrate 204, which in this example is a three-layer PCB. The three-layer PCB includes dielectric layers 208A-208C and metal layers 209A-D. Metal layers 209A-D include ground planes 211A-C that are connected (e.g., electrically coupled) by vias 212A-212B. In some embodiments, ground plane 211A (e.g., the ground plane of microstrips 214) is formed on metal layer 209B, which is disposed within an interior of substrate 204. Ground plane 211C is formed on metal layer 209D, which is on a bottom surface of substrate 204. Circulator 200 further includes a magnet 206 adjacent to ground plane 211C disposed on the bottom surface of substrate 204 (e.g., a neodymium or other rare-earth magnet).

Substrate 204 has a blind hole 216 (e.g., substrate 204 has a slot removed from its top surface). As used herein, the term “blind hole” refers to a hole that is reamed, drilled, milled, or otherwise manufactured to a specified depth without breaking through to the other side of the work piece (e.g., substrate 204). The etymology is that, since the hole does not go all the way through the work piece, it is not possible to see through the blind hole. In some embodiments, blind hole 216 in substrate 204 is a through hole through the top layer of the three-layer PCB (where the top layer includes a top dielectric layer 208A). In some embodiments, blind hole 216 is formed by fabricating a through hole in the top layer of the three-layer PCB before assembling the PCB.

Circulator 200 includes a plurality of conductive microstrips 214 disposed on a top surface of substrate 204 (e.g., microstrip 214A-214B, as well as a third microstrip not shown because of the perspective). In some embodiments, conductive microstrips 214 are formed by patterning top metal layer 209A of substrate 204. In some embodiments, a conductive microstrip is a conductive portion of a metal transmission line printed on the circuit board. An outer terminus of a conductive strip 214 is a port of circulator 200.

Circulator 200 includes ferrite disk 202 positioned within blind hole 216. Ferrite disk 202 is embedded below the top surface of substrate 204 (as shown in FIG. 2B). For example, ferrite disk 202 is a piece that is separate from substrate 204. Ferrite disk 202 sits in blind hole 216 so that a bottom of ferrite disk 202 is inset into (e.g., positioned below) the top surface of substrate 204. Thus, in some embodiments, ferrite disk 202 is entirely embedded into substrate 204. In some embodiments, ferrite disk 202 is positioned entirely within blind hole 216. In some embodiments, a depth of blind hole 216 is equal to a height of ferrite disk 202, within tolerances. In some embodiment, the depth of blind hole 216 is equal to a depth of the top layer of substrate 204 (e.g., the depth of dielectric layer 208A plus the depth/thickness of metal layer 209A, which may be minimal). In some embodiments, a top surface of ferrite disk 202 is flush with the top surface of conductive microstrips 214 (e.g., within tolerances of circulator 200). In some embodiments, the depth/thickness of conductive microstrips 214 is negligible so that, within tolerances, the top surface of ferrite disk 202 is flush with the top surface of substrate 204.

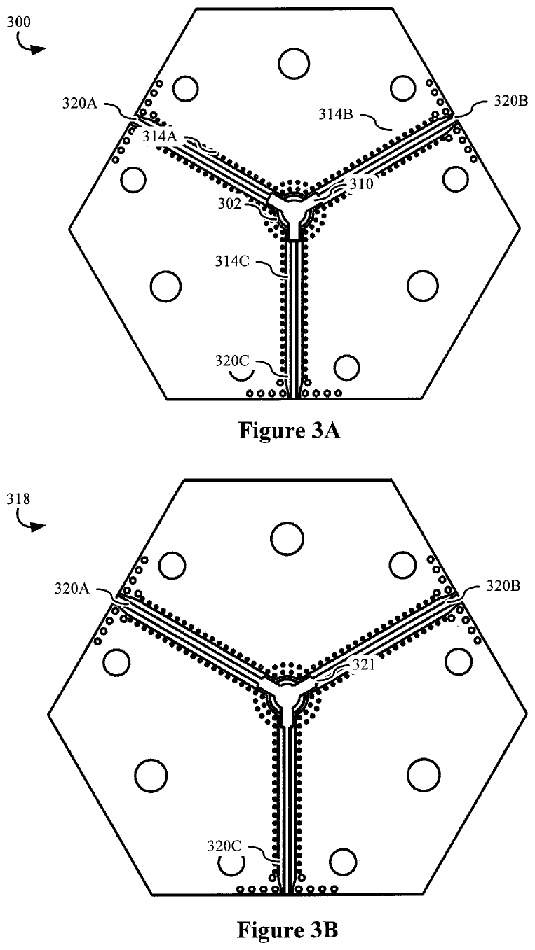

Circulator 200 also includes a flat (e.g., unbent) metal film 210 coupling a top surface of ferrite disk 202 to conductive microstrips 214. Metal layer 210 is disposed on the top surface of microstrip 214. In some embodiments, because ferrite disk 202 is inset into substrate 204, metal film 210 can be placed flush over ferrite disk 202 while maintaining electrical contact (e.g., conductive contact) with both ferrite disk 202 and conductive microstrips 214 (e.g., each of conductive microstrips 214). For example, flat metal film 210 is in direct contact with both the top surface of the ferrite disk 202 and each of the plurality of conductive microstrips 214. In some embodiments, as shown in FIG. 3A-3B, flat metal film 210 is patterned.

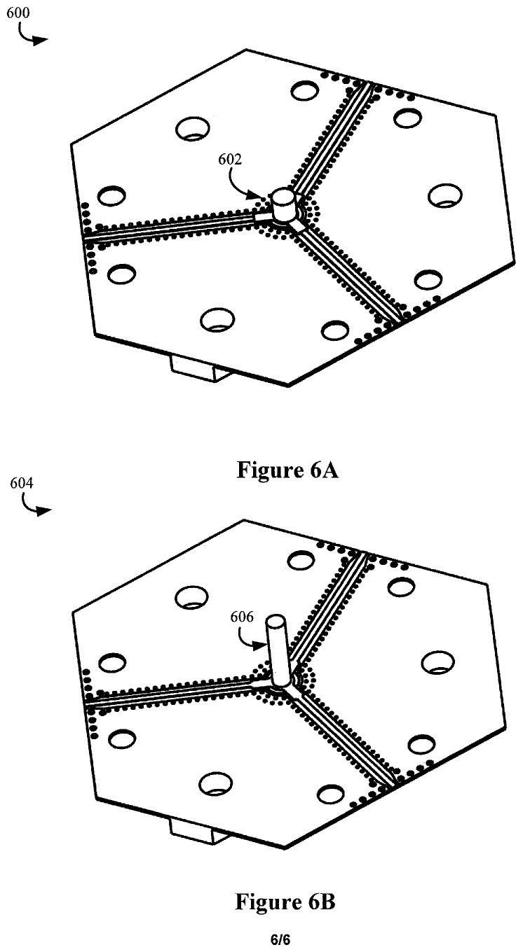

In some embodiments, although not shown, circulator 200 further includes a metal pin or a second magnet positioned above (e.g., on top of) patterned metal plate 210, as described with reference to FIGS. 6A-6B.

By embedding ferrite disk 202 in substrate 204 so that the top of ferrite disk 202 is flush with the top of substrate 204, circulator 200 eliminates the problems associated with the 3-D shaping of patterned metal plate 110 shown in FIGS. 1A-1B. Thus, the geometry of circulator 200 lessens the impedance mismatch by reducing the tolerances needed to fabricate the metal layer. In addition, flat metal film 210 is easily fabricated and assembled, thus reducing the cost of manufacturing. The following paragraphs describe two embodiments in further detail: partially- and fully-integrated microstrip circulators.

FIG. 3A is an illustration of a portion of a partially-integrated microstrip circulator, in accordance with some embodiments. As used herein, the term “partially-integrated microstrip circulator” means a circulator according to the embodiments described herein in which the metal film is a metal plate separate from the ferrite disk. In particular, FIG. 3A is an illustration of a three-port partially-integrated microstrip circulator 300. Thus, microstrip circulator 300 has three microstrips 314 (e.g., microstrips 314A-314C). The outer termini 320 of microstrips 314 form the various ports. In one example, terminus 320A of microstrip 314A is the S1 terminus, terminus 320B of microstrip 314B is the S2 terminus, and terminus 320C of microstrip 314C is the S3 terminus. Thus, if circulator 300 were an ideal device, circulator 300 would perfectly pass a signal from S1 to S2, from S2 to S3, and from S3 to S1. Further, if circulator 300 were an ideal device, circulator 300 would completely attenuate a signal from S2 to S1, from S3 to S2, and from S1 to S3.

Because no real circulator is ideal, circulators are characterized by insertion loss, return loss, and isolation. Insertion loss refers to the attenuation between two ports that are arranged, with respect to one another, in the rotation direction of circulator 300 (e.g., the direction for which circulator 300 is supposed to pass a signal). For example, the attenuation from S1 to S2 is referred to as the S-parameter S[2,1] insertion loss. Isolation refers to the attenuation between two ports that are arranged, with respect to each other, opposite the rotation direction of circulator 300 (e.g., the direction for which circulator 300 is supposed to attenuate signals). For example, the attenuation from S2 to S1 is referred to as the S-parameter S[1,2] isolation. Return loss refers to the power returned to a respective port relative to the incident power (e.g., as measured in decibels). For example, the power incident upon port S1 and returned to S1 is referred to as the S-parameter S[1,1] return loss.

Because circulator 300 is a partially-integrated microstrip circulator, circulator 300 includes a metal plate 310 soldered to microstrips 314 (e.g., soldered to each microstrip 314) that is positioned over a ferrite disk 302.

In accordance with some embodiments, circulator 300 can be fabricated as follows (1) a top metal layer of a substrate is patterned according to a desired circuit pattern; (2) a blind hole is fabricated into substrate; (3) metal plate 310 is fabricated from a thin metal sheet (e.g., a 30-38 gauge copper sheet metal, although the thickness may differ for different applications); (5) ferrite disk 302 is placed in the blind hole of the substrate, and (5) metal plate 310 is aligned to at least partially cover ferrite disk 302 and subsequently soldered to the microstrips 314.

The partially-integrated microstrip circulator 300 shown in FIG. 3A has been designed, fabricated, assembled, and tested in the 23 GHz band. Solder has been used to connect metal plate 310 to ferrite disk 302 and microstrips 314 on the printed circuit board. Two ports of circulator 300 have been tested with a third port being matched by a 50Ω matching load. The tested isolation is about 9 dB with a broad bandwidth of at least 20 GHz to 24.5 GHz (the bandwidth was limited in the tests by a frequency range of the measurement equipment). The measured insertion loss is better than 1.2 dB and the return losses are better than 9 dB and 12 dB for different ports.

FIG. 3B is an illustration of a portion of a fully-integrated microstrip circulator 318, in accordance with some embodiments. As used herein, the term “fully-integrated microstrip circulator” means a circulator according to the embodiments described herein in which the metal film is a metallization layer deposited on the ferrite disk in lieu of a metal plate and soldering. In a fully-integrated microstrip circulator, there is no separate metal plate on the top of the ferrite disk, so there is no soldering during the assembly of the metal film with respect to the ferrite disk and the microstrips. Thus, circulator 318 includes a metal layer 321 in lieu of metal plate 310. The difference between FIG. 3A and FIG. 3B is subtle: the only visual difference is that because metal layer 321 is deposited on the ferrite disk and the microstrips, metal layer 321 is continuous with microstrips 320 in FIG. 3B whereas metal plate 310 is separate from microstrips 320 in FIG. 3A. Otherwise, circulator 318 shown in FIG. 3B is analogous to circulator 300 shown in FIG. 3A.

In some circumstances, a fully-integrated microstrip circulator can be fabricated with reduced assembly time and improved (e.g., reduced) discontinuity of the signal paths (e.g., RF signal paths). Accordingly, the fabrication process of microstrip circulator 318 is follows: (1) a top metallization layer of substrate is patterned according to a desired circuit pattern; (2) a blind hole in the top layer of the substrate is fabricated; (3) the ferrite disk is fixed in place in the blind hole; (4) a thin layer of metal 320, such as silver or copper, is deposited on the top surface of the ferrite disk; and (5) a desired circuit pattern is etched into the layer of metal (alternatively, a mask can be used to pattern the desired circuit pattern when it is deposited). Lastly, (6) the circuit pattern on the top of ferrite disk is connected with the circuit on substrate (e.g., metallization technique or plating). Using this approach, the soldering step is unnecessary, thus making the assembly much easier and reducing discontinuities due to the soldering.

The fully-integrated microstrip circulator 318 shown in FIG. 3B has been designed, fabricated, assembled, and tested in the 23 GHz band. Tested isolation for the fully-integrated microstrip is better than 9 dB in the whole test range, from 20 GHz to 24.5 GHz. From 21.8 GHz to 24.5 GHz, the isolation is better than 15 dB. The bandwidth of the test range was again limited by the measurement equipment. Thus, the real bandwidth is expected to be larger. Compared to partially-integrated circulator 300, isolation is improved by about 5 dB from 21.8 GHz to 24.5 GHz; whereas return loss is improved about 3 dB in the frequency range of 21.8 GHz to 24.5 GHz.

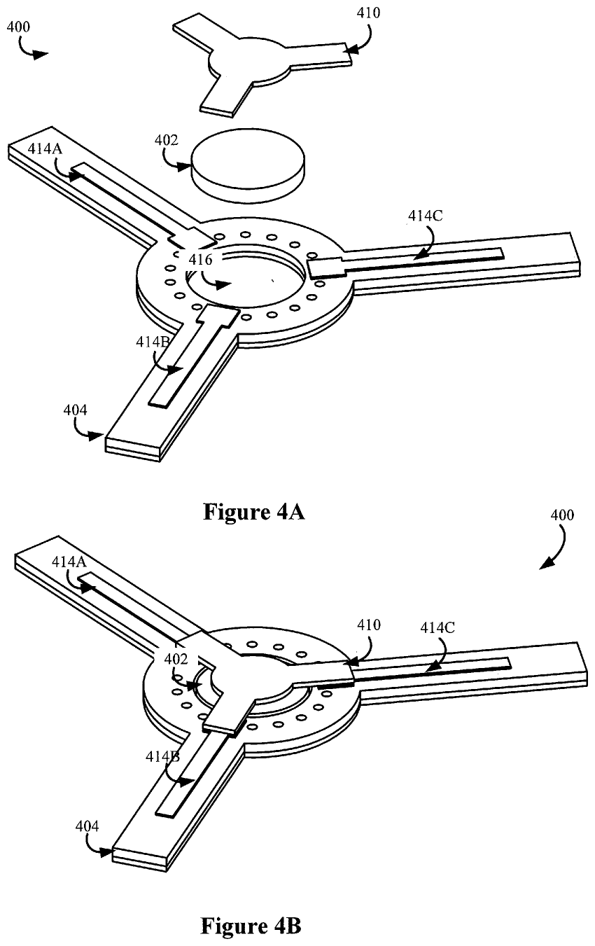

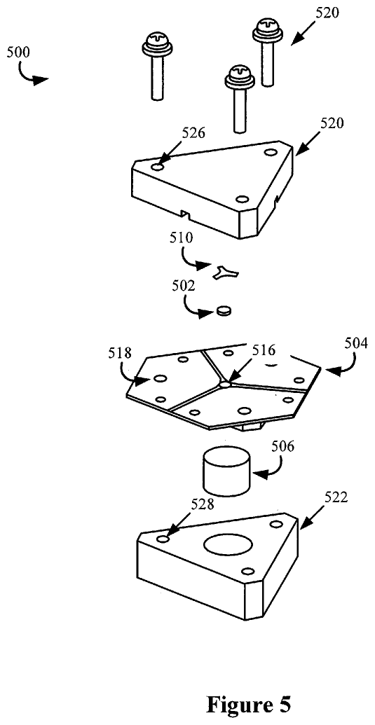

FIG. 4A illustrates a perspective exploded view of a portion of a partially integrated microstrip circulator 400, in accordance with some embodiments. FIG. 4B illustrates a perspective assembled view of the portion of the microstrip circulator 400, in accordance with some embodiments. Microstrip circulator 400 is analogous to microstrip circulator 200 (FIGS. 2A-2B). For example, circulator 400 includes:
ferrite disk 402 that is analogous to ferrite disk 202;
substrate 404 that is analogous to substrate 204. Although substrate 404 is shown having a particular shape (e.g., three-pronged with a circular center), substrate 404 need not be shaped in any particular way. For example, FIG. 5 illustrates embodiments in which the substrate has a hexagonal shape. Substrate 404 can have any shape, as dictated by design considerations (e.g., packaging);
metal plate 410 which is analogous to metal film 210 (e.g., this example illustrates a metal plate rather than a metallization layer, although a metallization layer is compatible with the embodiments shown in FIGS. 4A-4B);
microstrips 414A-C that are analogous to microstrips 214A-C; and
blind hole 416 that is analogous to blind hole 216.

FIG. 5 illustrates an exploded view of a microstrip circulator assembly 500, in accordance with some embodiments. The microstrip circulator assembly 500 includes several components that are analogous to embodiments previously described. For example, circulator assembly 500 includes:
ferrite disk 502 that is analogous to ferrite disk 202;
substrate 504 that is analogous to substrate 204. FIG. 5 illustrates embodiments in which substrate 504 has a hexagonal shape. As noted above, substrate 504 can have any shape, as dictated by design considerations (e.g., packaging). Substrate 504 also includes screw holes 518 for screws 524 to pass through;
magnet 506 that is analogous to magnet 206;
metal plate 510 which is analogous to metal film 210 (e.g., this example illustrates a metal plate rather than a metallization layer, although a metallization layer is compatible with the embodiments shown in FIG. 5);
microstrips (not numbered for visual clarity) that are analogous to microstrips 214A-C; and
blind hole 516 that is analogous to blind hole 216.

In addition, microstrip circulator assembly 500 includes several packaging components, including a cover 520 (e.g., an aluminum cover), a base 522 (e.g., an aluminum base), and screws 524. Cover 520 includes unthreaded through holes 526. Base 522 includes threaded holes 528. Screws 524 pass through holes 526 in cover 520, pass through holes 518 in substrate 504, and are screwed into holes 528 in base 522. However, FIG. 5 provides just one example. One of ordinary skill in the art will recognize other ways to package the circulator.

In some embodiments, microstrip circulator assembly 500 further includes a metal pin or a second magnet positioned above (e.g., on top of) metal plate 510, as described with reference to FIGS. 6A-6B.

FIG. 6A is an illustration of a partially-integrated microstrip circulator 600 having a second magnet 602 on top of the metal film (e.g., the metal plate or metallization layer), in accordance with some embodiments. In some embodiments, second metal pin 602 is directly on top of the metal film. In some embodiments, second magnet 602 is coupled with a surface of the metal film that is distal to the top surface of the ferrite disk. Thus, circulator 600 includes two magnets, one below the ferrite disk/substrate as shown in FIG. 5 as well as second magnet 602 above the ferrite disk. In some embodiments, the diameter of the second magnet is smaller than that of the ferrite disk, which in turn has a small diameter than the first magnet (e.g., magnet 206, FIGS. 2A-2B). In some circumstances, the magnetic field of a single magnet (e.g., magnet 206, FIGS. 2A-2B) is insufficient to meet the isolation requirements for a particular application. This is especially true when inexpensive magnets are used (e.g., cheap neodymium magnets). On the other hand, high-grade magnets with stronger magnetic fields are very expensive, in some cases prohibitively so. To improve the isolation of the microstrip circulators described herein, some embodiments employ second magnet 602 to enhance the magnetic field in the ferrite disk. In some embodiments, the size of second magnet 602 is smaller than that of the ferrite disk. For example, in FIG. 6A, second magnet 602 is 2 mm in diameter and 2 mm in height. In test results for circulator 600, for a measured frequency range of 20 GHz to 24.5 GHz, the measured isolation was better than 21 dB, which matches the common requirements of circulators in wireless communication system. The tested insertion loss is better than 1 dB in the frequency range of 20 GHz to 24.5 GHz and the return loss is better than 15 dB from 20.9 GHz to 24.5 GHz, a 5 dB improvement, compared to circulator 300 without the second magnet.

FIG. 6B is an illustration of a fully-integrated microstrip circulator 604 having a metal pin 606 on top of the metal film (e.g., the metal plate or metallization layer), in accordance with some embodiments. In some embodiments, metal pin 606 is directly on top of the metal film. In some embodiments, metal pin 606 is coupled with a surface of the metal film that is distal to the top surface of the ferrite disk. In some embodiments, the diameter of the metal pin is smaller than that of the ferrite disk, which in turn has a small diameter than the magnet (e.g., magnet 206, FIGS. 2A-2B). For an even simpler design to improve the isolation of the microstrip circulators described herein, metal pin 606 is introduced in the circulator design to serve a similar function as that of second magnet 602 (FIG. 6A). In some embodiments, metal pin 606 holds down the metal plate (e.g., metal plate 510, FIG. 5) so that the contact between the metal plate and the ferrite disk is improved. In some embodiments, the diameter of metal pin 606 is smaller than that of the ferrite disk. The length of metal pin 606 is chosen based on design needs. In some embodiments, metal pin 606 is a ferromagnetic metal alloy. In some embodiments, metal pin 606 is a paramagnetic alloy. In some embodiments, metal pin 606 is made of steel. For example, metal pin 606 shown in FIG. 6B is steel with a diameter of 1.6 mm. For the same range of frequencies described above, the isolation of circulator 604 shown in FIG. 6B was better than 13 dB from 20 GHz to 24.5 GHz. In the frequency range between 21.35 GHz to 24.5 GHz, the isolation has been even better than 20 dB. Return loss and insertion loss are improved as well.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles of the disclosure and its practical applications, to thereby enable others skilled in the art to best utilize the various implementations with various modifications as are suited to the particular use contemplated.

It will be understood that, although the terms “first,” “second,” etc. are sometimes used herein to describe various elements, these elements should not be limited by these terms. These terms are only used to distinguish one element from another. For example, a first element could be termed a second element, and, similarly, a second element could be termed a first element, without changing the meaning of the description, so long as all occurrences of the “first element” are renamed consistently and all occurrences of the second element are renamed consistently. The first element and the second element are both elements, but they are not the same element.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

Throughout the preceding description, various implementations are described within the outdoor units and antenna assemblies. This is purely for convenience of explanation and is not intended to limit the claims that follow. Various implementations described can be implemented in waveguide applications of any sort.

What is claimed is:

1. A circulator, comprising:
a substrate having a blind hole, the substrate having one or more dielectric layers and one or more conductive layers, including a top conductive layer on a top surface of the substrate;
a plurality of conductive microstrips formed on the top conductive layer on the top surface of the substrate;
a ferrite disk positioned within the blind hole, wherein a top surface of the ferrite disk is flush with a top surface of the plurality of conductive microstrips; and
a flat metal film coupling a top surface of the ferrite disk to the conductive microstrips disposed on the top surface of the substrate.

2. The circulator of claim 1, wherein:
the substrate comprises:
a first ground plane formed from a respective conductive layer of substrate, the respective conductive layer being disposed within an interior of the substrate; and
a second ground plane formed from a bottom conductive layer of the substrate, the bottom conductive layer being disposed on a bottom surface of the substrate; and
the circulator further comprises a magnet coupled with the second ground plane disposed on the bottom surface of the substrate.

3. The circulator of claim 2, further comprising:
a second magnet coupled with a surface of the flat metal film that is distal to the top surface of the ferrite disk.

4. The circulator of claim 2, further comprising:
a metal pin that is coupled with a surface of the flat metal film that is distal to the top surface of the ferrite disk.

5. The circulator of claim 1, wherein the flat metal film comprises a metallization layer on the top surface of the ferrite disk.

6. The circulator of claim 1, wherein the flat metal film is a flat metal plate.

7. The circulator of claim 1, wherein each of the plurality of conductive microstrips is electrically coupled by the flat metal film to pass a signal between respective conductive microstrips of the plurality of microstrips according to a rotation direction of the circulator.

8. The circulator of claim 1, wherein the circulator is a three-port microstrip circulator.

9. The circulator of claim 1, wherein the blind hole goes through a top dielectric layer of the substrate without going into any other dielectric layers of the substrate.
